(19) United States
(12) Patent Application Publication
(10) Pub. No.: US 2012/0146527 A1
(43) Pub. Date: Jun. 14, 2012

(54) LED DRIVING CIRCUIT

(75) Inventor: Cheng-Hung PAN, Taipei (TW)

(73) Assignee: LUXUL TECHNOLOGY INCORPORATION, Taipei (TW)

(21) Appl. No.: 13/310,948

(22) Filed: Dec. 5, 2011

Related U.S. Application Data
(60) Provisional application No. 61/422,144, filed on Dec. 11, 2010.

(51) Int. Cl. H05B 37/02

(52) U.S. Cl. 315/201

(57) ABSTRACT

An LED driving circuit includes a rectifying unit connected to an AC power, an LED unit, a voltage-controlled transistor, a current detection unit, a low-pass filter and a current control unit. The rectifying unit, the LED unit, the voltage-controlled transistor and the current detection unit are connected in series to form a current loop. The current detection unit generates a square DC voltage signal representing the current flow in the current loop. The low-pass filter transfers the square DC voltage signal to an average voltage signal. The current control unit compares the average voltage signal to a reference voltage. According to the result of the comparing, the current control unit outputs a corresponding control signal to the voltage-controlled transistor to maintain the current flow in the current loop as a constant. Therefore, the brightness of the LED unit can be uniform.

### CROSS-REFERENCE TO RELATED APPLICATIONS

This application claims the benefit of the U.S. provisional patent application No. 61/422,144, filed on Dec. 11, 2010, the disclosure of which is incorporated herein in its entirety by reference.

### BACKGROUND OF THE INVENTION

1. Field of the Invention

The present invention relates to a driving circuit, and more particularly to an LED driving circuit.

2. Description of Related Art

A light-emitting diode (LED) is developed with advantages of high brightness and low power dissipation, and takes the place of conventional bulbs.

The LED is an electric device that is activated by a forward bias voltage, and allows a current flow to pass in the forward direction. With reference to FIG. 7, an LED driving circuit comprises a full wave rectifier 21, a DC-to-DC converter 22 and an LED unit 20. If an AC power AC/IN is desired to couple to the LED unit 20, the full wave rectifier 21 and the DC-to-DC converter 22 will be necessary. The full wave rectifier 21 and the DC-to-DC converter 22 are electrically connected between the AC power AC/IN and the LED unit 20. The AC power AC/IN, the full wave rectifier 21, the DC-to-DC converter 22 and the LED unit 20 form a current loop.

The full wave rectifier 21 has an input terminal and an output terminal. The input terminal is electrically connected to the AC power AC/IN. The output terminal outputs a sine DC voltage.

The DC-to-DC converter 22 has an input terminal Vi and an output terminal Vo. The input terminal Vi is electrically connected to the output terminal of the full wave rectifier 21. The output terminal Vo of the DC-to-DC converter 22 is electrically connected to the LED unit 20. The DC-to-DC converter 22 converts the sine DC voltage to a constant voltage as a forward bias voltage for activating the LED unit 20.

There are two types of the DC-to-DC converter 22. With reference to FIG. 8, a first type DC-to-DC converter 22′ comprises a voltage regulator 220′, a voltage detection unit 221′ and a control unit 222′. The voltage regulator 220′ and the voltage detection unit 221′ are electrically connected in series between the full wave rectifier 21 and LED unit 20. The control unit 222′ is electrically connected to the voltage regulator 220′, the voltage detection unit 221′, and a reference voltage Vref. The voltage detection unit 221′ is a resistive device. The voltage detection unit 221′ couples an output voltage Vo to the control unit 222′. The control unit 222′ compares the amplitudes of the output voltage Vo from the voltage detection unit 221′ to the reference voltage Vref. If the output voltage is larger than the reference voltage Vref, that indicates the voltage of the output Vo is too large. Therefore, the control unit 222′ raises the resistance of the voltage detection unit 221 to decrease the output voltage Vo from the voltage detection unit 221′. If the output voltage Vo from the voltage detection unit 221′ is lower than the reference voltage Vref, that indicates the output voltage is too low. Therefore, the control unit 222′ reduces the resistance of the voltage detection unit 221 to raise the output voltage Vo.

However, the voltage regulator 220′ is a resistive device that will cause heat dissipation. According to the power efficiency formula, E=Po/Pi=(VoIo/ViIi), the ratio of Vo to Vi indicates the quality of the power efficiency when Io=Ii, and Vi and Vo are the input voltage and the output voltage of the DC-to-DC converter 22 respectively. In other words, the lower voltage activating the LED unit 20, the worse power efficiency appears.

To improve the power efficiency, with reference to FIG. 9, a switching power supply without the voltage regulator is disclosed as a second type of the DC-to-DC converter 22. The DC-to-DC converter 22 mainly comprises a transformer T, an active switch 30, an isolation feedback circuit 34 and a PWM controller 35. The transformer T has a primary side and a secondary side. The primary side is electrically connected to the output terminal of the full wave rectifier and an energy-storing capacitor C. The secondary side is electrically connected to an output inductor 32 and an output capacitor 33 wherein the output inductor 32 and the output capacitor 33 are connected in series. An output voltage Vo of the output capacitor 33 is set as the output voltage of the DC-to-DC converter 22.

The active switch 30 is electrically connected to the primary side of the transformer T. The active switch 30 has a control terminal.

The PWM controller 35 is electrically connected to a reference voltage Vref, the control terminal of the active switch 30 and the output capacitor 33 via the isolation feedback circuit 34. The isolation feedback circuit 34 is responsible for obtaining the output voltage Vo. The PWM controller 35 outputs a PWM signal to the active switch 30 based on the difference between the output voltage Vo and the reference voltage Vref. The pulse width of the PWM signal changes with the difference between the output voltage Vo and the reference voltage Vref. Therefore, the output voltage Vo can be controlled in a constant value. The DC-to-DC converter 22 improves the power efficiency because there are no resistive voltage regulators used.

Capacitors and inductors such as the energy-storing capacitor C, the output capacitor 33 and the output inductor 32 are used. However, the capacitors and the inductors will generate a reactive power when the AC power is inputted to the LED driving circuit. The power factor of the LED driving circuit mentioned above is low because of the existence of the capacitors C, 33 and inductors 32. In order to improve the power factor, a power factor correction 37 should be connected to the primary side of the transformer T. The power factor correction 37 will increase the circuit complication and the cost. Especially, it is hard to miniaturize the size of the LED driving circuit because the sizes of the output inductor 32 and the output capacitor 33 are large. In addition, the output inductor 32 and the transformer T will induce an electromagnetic wave around and cause electromagnetic interference.

With reference to FIG. 10, a constant current LED driving circuit comprises a full wave rectifier 21, a DC-to-DC converter 22 and a low dropout regulator (LDO) 4. The full wave rectifier 21 and the DC-to-DC converter 22 are electrically connected between the AC power AC/IN and the low dropout regulator 4. The low dropout regulator 4 comprises an LED unit 40, a voltage-controlled transistor 41, a voltage divider circuit 42 and a comparator 43.

In this case, the LED unit 40, the voltage-controlled transistor 41 and the voltage divider circuit 42 are connected in series. The voltage-controlled transistor 41 has a control terminal. The voltage divider circuit 42 consists of two resistors connected in series.

The comparator 43 has a first input terminal, a second input terminal and an output terminal. The first input terminal is electrically connected to a reference voltage Vref. The second input terminal is electrically connected to the voltage divider circuit 42. The output terminal of the comparator 43 is electrically connected to the control terminal of the voltage-controlled transistor 41. The comparator 43 outputs a control signal to the voltage-controlled transistor 41 to adjust a driving current IDS flowing through the LED unit 40 based on the comparison result of the reference voltage Vref and the voltage output from the voltage divider circuit 42. If the current IDS remains stable, the brightness of the LED unit 40 will be uniform.

However, because the low dropout regulator 4 is driven by a DC voltage, the full wave rectifier 21 and the DC-to-DC converter 22 have to be connected to the low dropout regulator 4. The disadvantages of the DC-to-DC converter 22 as mentioned above can hardly be avoided.

### SUMMARY OF THE INVENTION

The main objective of the present invention is to provide an LED driving circuit without the large capacitors and the inductors. The LED driving circuit could activate the LED in uniform brightness.

The LED driving circuit comprises a rectifying unit, an LED unit, a voltage-controlled transistor, a current detection unit, a low-pass filter and a current control unit.

The rectifying unit has an output terminal to output a DC voltage. The LED unit comprises multiple LED modules connected to the rectifying unit. A current loop is formed by an AC power, the rectifying unit and the LED unit. The voltage-controlled transistor is connected to the current loop in series to adjust a current flow in the current loop. The current detection unit is connected to the current loop in series, and generates a square DC voltage signal representing the current flow in the current loop. The low-pass filter is connected to the current detection unit, and transfers the square DC wave voltage signal to an average voltage signal. The current control unit has a first input terminal, a second input terminal and an output terminal. The first input terminal is connected to the low-pass filter to receive the average voltage signal. The second input terminal is connected to a reference voltage. The output terminal is connected to the control terminal of the voltage-controlled transistor to output a control signal to the voltage-controlled transistor.

The current control unit compares the amplitudes of the average voltage signal to the reference voltage. According to the result of the comparing, the current control unit generates a corresponding control signal to the voltage-controlled transistor to stabilize the current flow in the current loop. In this invention, the AC power is able to be connected to the rectifying unit directly. The LED driving circuit will transfer a DC voltage from the AC power to a stable DC voltage to activate the LED unit without any additional DC-to-DC converter. Because the transformer, the inductors and the capacitors described in the prior are not used in this invention, the power factor is improved without the power factor correction. On the other hand, the complication of the LED driving circuit is reduced, and the size of the LED driving circuit can be smaller.

Other objectives, advantages and novel features of the invention will become more apparent from the following detailed description when taken in conjunction with the accompanying drawings.

### BRIEF DESCRIPTION OF THE DRAWINGS

FIG. 1 is a block diagram of an embodiment of an LED driving circuit in accordance with the present invention;

FIG. 2 is a first configuration of an LED unit to be controlled by the LED driving circuit in accordance with the present invention;

FIG. 3 is a second configuration of an LED unit to be controlled by the LED driving circuit in accordance with the present invention;

FIG. 4 is a VDS-versus-IDS waveform diagram of a voltage-controlled transistor;

FIG. 5A is a sine DC voltage waveform diagram;

FIG. 5B is a waveform diagram of the voltage from the voltage divider circuit;

FIG. 6 is a block diagram of a sinc filter;

FIG. 7 is an LED driving circuit block diagram comprising an LED unit, a full wave rectifier and a DC-to-DC converter;

FIG. 8 is a block diagram of a conventional DC-to DC converter;

FIG. 9 is another block diagram of a conventional DC-to DC converter;

FIG. 10 is a block diagram of a constant current LED driving circuit comprising a low dropout regulator.

### DETAILED DESCRIPTION OF THE PREFERRED EMBODIMENT

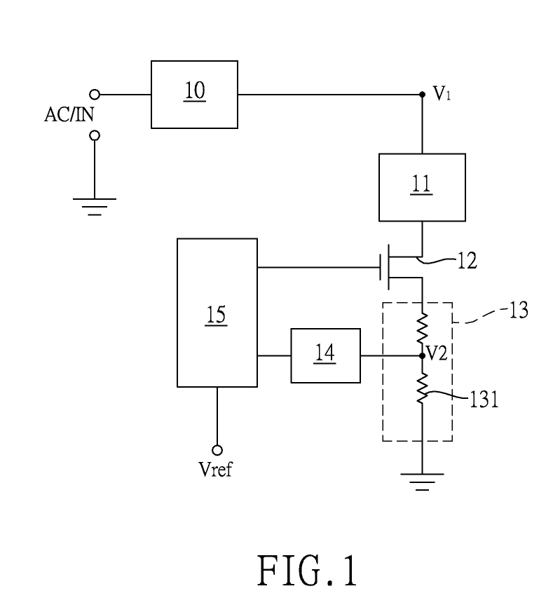

With reference to FIG. 1, a first embodiment of this invention comprises a rectifying unit 10, an LED unit 11, a voltage-controlled transistor 12, a current detection unit 13, a low-pass filter 14 and a current control unit 15.

The rectifying unit 10 has an input terminal and an output terminal. The input terminal is electrically connected to an AC power AC/IN. The output terminal outputs a DC voltage transformed from the AC power. The rectifying unit 10 may be a half wave rectifier or a full wave rectifier. In this embodiment, the rectifying unit 10 is a full wave rectifier that outputs a full wave sine DC voltage.

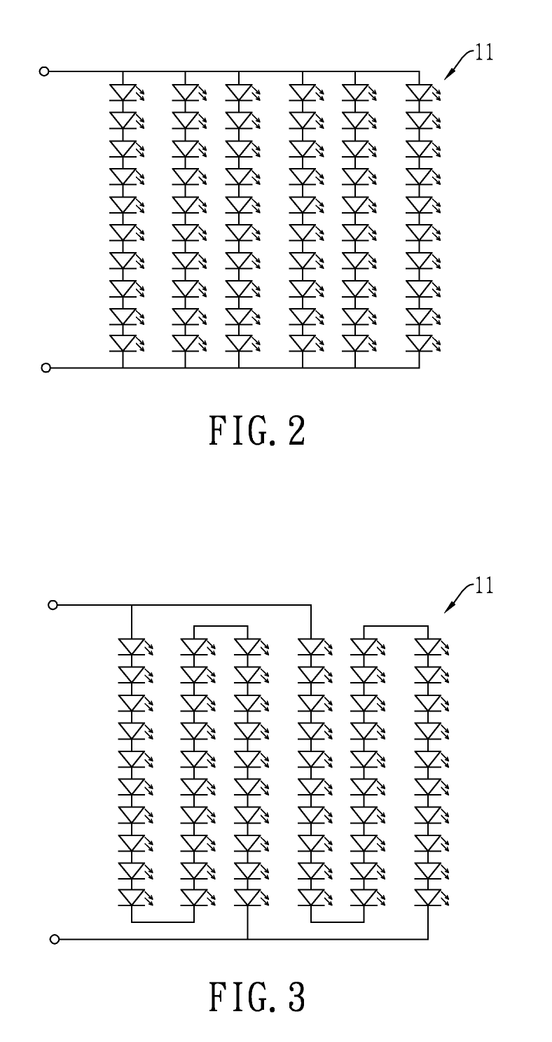

The LED unit 11 comprises multiple LED light sources, and is electrically connected to the rectifying unit 10. The AC power AC/IN, the rectifying unit 10 and the LED unit 11 form a current loop. With reference to FIG. 2 and FIG. 3, two topologies of two different LED units 11 are illustrated respectively. The multiple LED light sources are electrically connected in series to form an LED module, and the multiple LED modules can be electrically connected in parallel. According to a simplified formula of the power efficiency E, E=Vo/Vi, the ratio of Vo to Vi indicates the quality of the power efficiency wherein the Vo stands for a bias voltage that activates the LED unit 11 and Vi is a constant. The higher bias voltage Vo indicates the greater power efficiency.

With reference to FIG. 2, the LED unit 11 has six LED modules connected in parallel as an example, and each LED module has ten LED sources and the threshold voltage of each LED source is 3.3V. The bias voltage should be above 33V to activate the LED unit 11.

With reference to FIG. 3, the LED unit 11 has two LED modules connected in parallel as an example, and each LED module has thirty LED sources and the threshold voltage of each LED source is 3.3V. The bias voltage should be above 99V to activate the LED unit 11. As a result, the bias voltage for the LED unit 11 of FIG. 3 is larger than that of FIG. 2. According to the simplified power efficiency formula E=Vo/Vi, the power efficiency in FIG. 3 is better than that in FIG. 2.

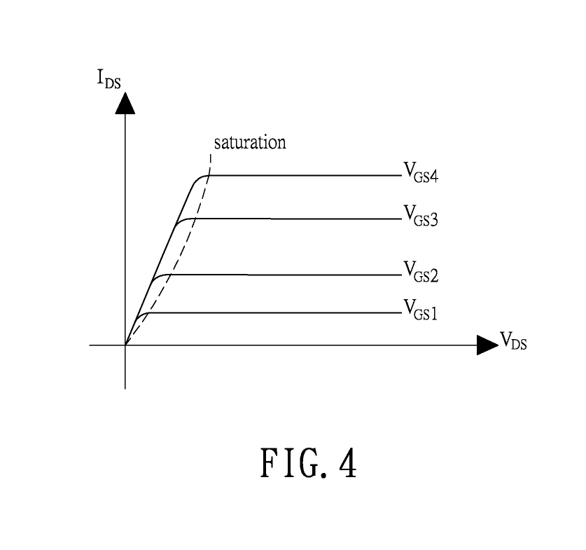

The voltage-controlled transistor 12 is electrically connected to the current loop in series, and has a control terminal. The voltage-controlled transistor 12 adjusts the current flow in the current loop. The voltage-controlled transistor 12 can be a MOSFET, a JFET or an IGBT. In this embodiment, the voltage-controlled voltage is a MOSFET having a gate, a drain and a source. The drain and the source are connected to the current loop in series. The gate is used as the control terminal. With reference to FIG. 4, the MOSFET is operated in the saturation region, and the amplitude of the current flow IDS passing through the current loop is adjustable by controlling the bias voltage between the gate and the drain.

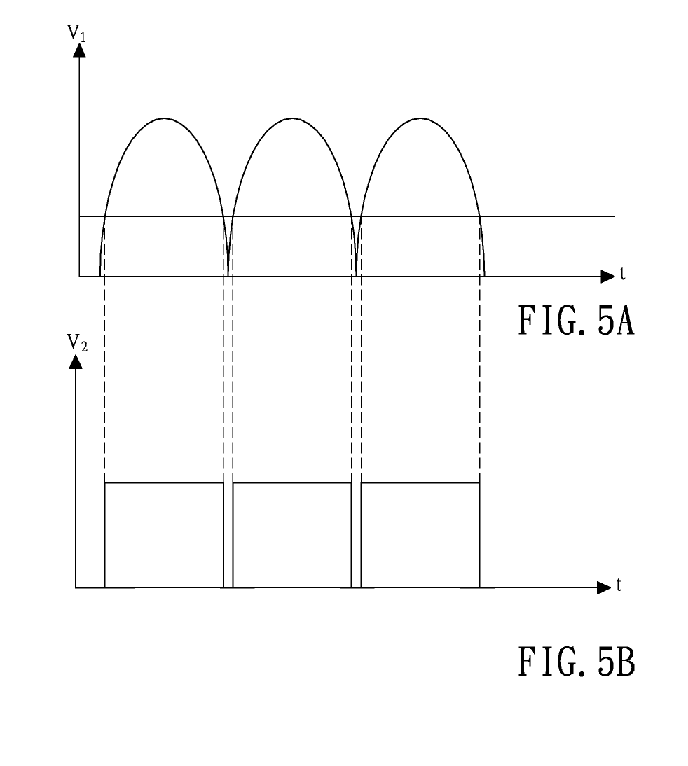

The current detection unit 13 is electrically connected to the current loop in series. The current detection unit 13 may be a resistor 131 or a voltage divider circuit. With reference to FIG. 5A, a waveform diagram of an output voltage V1 from the rectifying unit 10 is illustrated. With reference to FIG. 5B, a waveform diagram of a voltage V2 of the resistor 131 is illustrated. The sine DC voltage from the rectifying unit 10 is transferred to a square DC voltage signal. The voltage V2 of the resistor 131 represents the current flow IDS in the current loop.

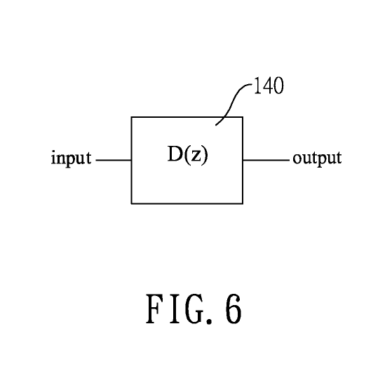

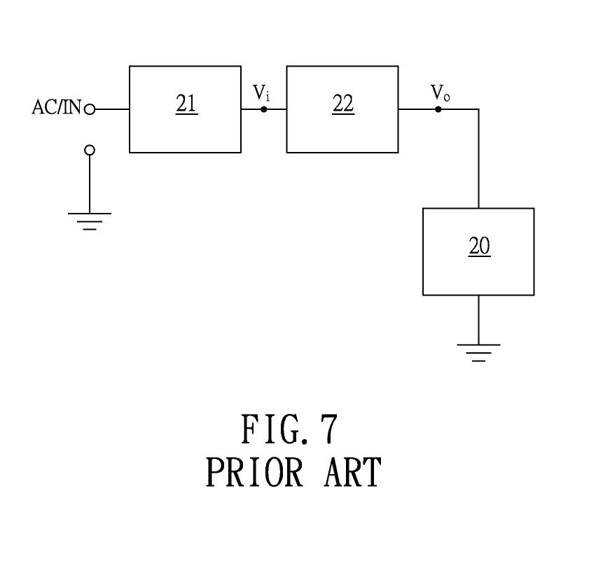

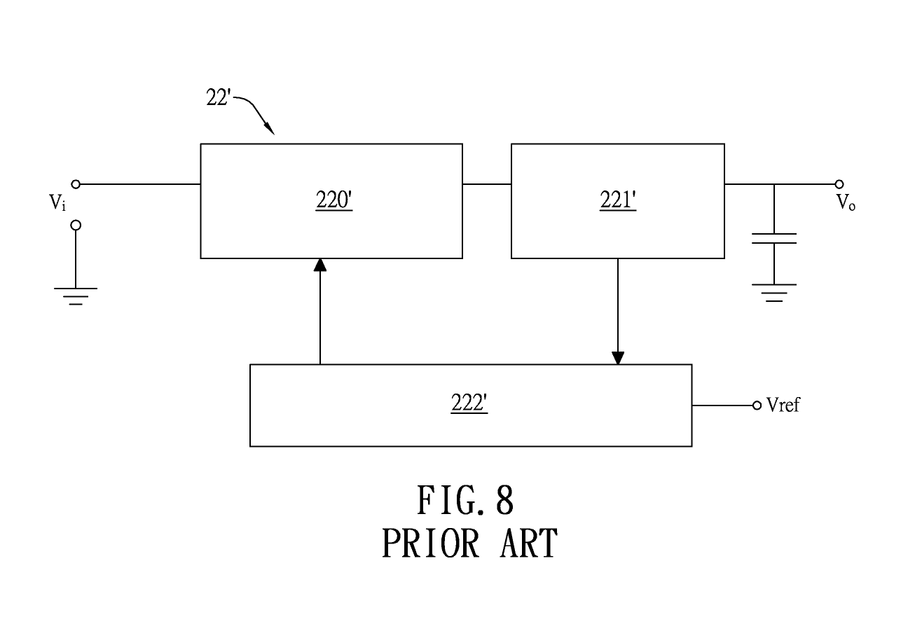

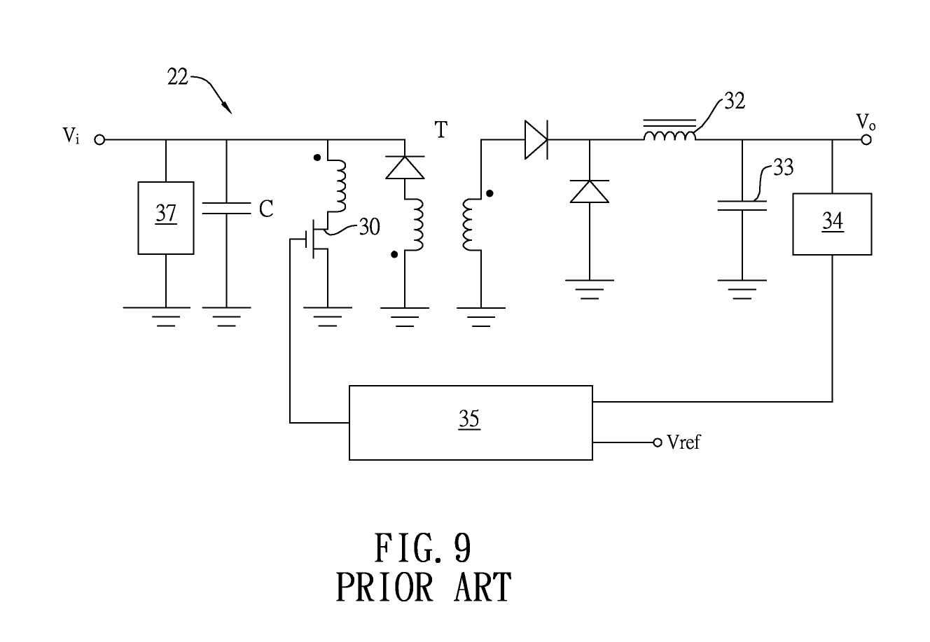

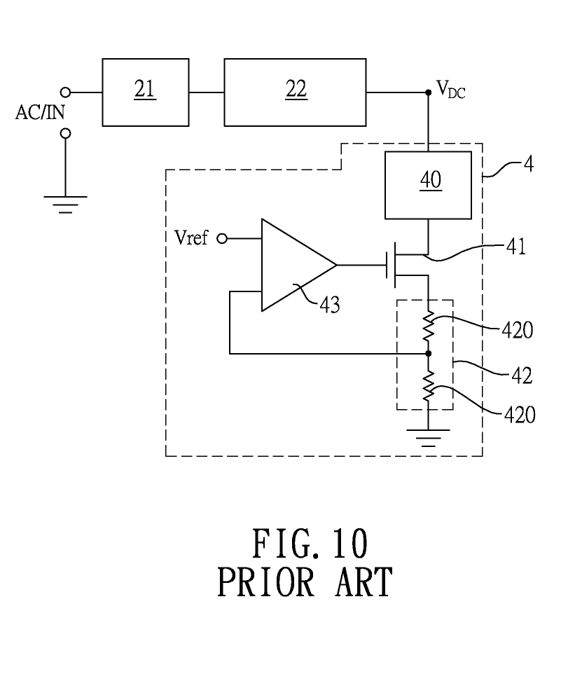

The low-pass filter 14 has an input terminal and an output terminal. The input terminal is electrically connected to the current detection unit 13 to receive the square DC voltage signal. The low-pass filter 14 can be a digital or an analog filter comprising capacitors and inductors. In this embodiment, the low-pass filter 14 is a down-sampled sinc filter. With reference to FIG. 6, a block diagram of a sinc filter 140 is disclosed. The sinc filter 140 can be defined as a z-transform expression:

$$D ( z ) = ( \frac{1}{M} \cdot \frac{1 - {z}^{- M}}{1 - {z}^{- 1}} )$$

where M is a decimation ratio. The low pass filter 14 oversamples and transfers the square DC voltage signal to an average voltage signal. The average voltage signal represents an average current flow in the current loop. The average voltage signal is outputted from the output terminal of the low-pass filter 14 to the current control unit 15.

The current control unit 15 has a first input terminal, a second input terminal and an output terminal. The first input terminal is electrically connected to the output terminal of the low-pass filter 14 to receive the average voltage signal. The second input terminal is electrically connected to a reference voltage Vref. The output terminal of the current control unit 15 is electrically connected to the control terminal of the voltage-controlled transistor 12 to output a control signal to the voltage-controlled transistor 12. The reference voltage Vref is determined based on a target current value to achieve the current loop.

To stabilize the current flow in the current loop, the current control unit 15 generates a control signal to activate the voltage-controlled transistor 12. The control signal is based on the comparison result between the average voltage signal and the reference voltage Vref. If the amplitude of the average voltage signal is larger than the reference voltage Vref, that indicates the average current flow passing through the LED unit 11 is relatively large. The current control unit 15 will decrease the bias voltage between the gate and the source of the voltage-controlled transistor 12 to decrease the average current in the current loop. On the contrary, if the amplitude of the average voltage signal is lower than the reference voltage Vref, that indicates the average current flow passing through the LED unit 11 is relatively low. The current control unit 15 enhances the bias voltage between the gate and the source of the voltage-controlled transistor 12 to raise the average current in the current loop. Above all, the average current in the current loop is controllable to suit the LED unit 11.

For example, the frequency of the AC power is 60 Hz. The AC power is transferred to a full wave sine DC voltage with a frequency of 120 Hz by the rectifying unit 10. The full wave sine DC voltage is used to activate the LED unit 11. When the transient amplitude of the full wave sine DC voltage is lower than the bias voltage of the LED unit 11, the LED unit 11 will be extinguished. The condition mentioned above will cause the LED unit 11 to flash. However, the flash is unobservable for naked eyes. In addition, in each cycle of the sine DC voltage, the LED unit 11 will become brighter if the larger average current passes through the LED unit 11. On the contrary, the LED unit 11 will become darker if the lower average current passes through the LED unit 11.

In this embodiment, the low-pass filter 14 receives the square DC voltage signal generated from the current detection unit 13, and transfers the square DC voltage signal to the average voltage signal. When the current control unit 15 receives the average voltage signal, the current control unit 15 compares the amplitudes of the average voltage signal to the reference voltage Vref. According to the comparison result between the average voltage signal and the reference voltage Vref, the current control unit 15 generates a corresponding control signal to activate the voltage-controlled transistor 12 to maintain the average current in the current loop being constant. The brightness of the LED unit 11 will be uniform because the average current in the current loop is stable.

Even though numerous characteristics and advantages of the present invention have been set forth in the foregoing description, together with details of the structure and features of the invention, the disclosure is illustrative only. Changes may be made in the details, especially in matters of shape, size and arrangement of parts within the principles of the invention to the full extent indicated by the broad general meaning of the terms in which the appended claims are expressed.

What is claimed is:

1. An LED driving circuit comprising
a rectifying unit having
an input terminal connected to an AC power; and
an output terminal outputting a DC voltage;
an LED unit having multiple LED modules and connected to the output terminal of the rectifying unit, wherein a current loop is formed by the AC power, the rectifying unit and the LED unit;
a voltage-controlled transistor connected to the current loop in series to adjust a current flow in the current loop, and having a control terminal;
a current detection unit connected to the current loop in series and generating a square DC voltage signal representing the current flow in the current loop;
a low-pass filter connected to the current detection unit and transferring the square DC voltage signal to an average voltage signal;
a current control unit having
a first input terminal connected to the low-pass filter to receive the average voltage signal;
a second input terminal connected to a reference voltage; and
an output terminal connected to the control terminal of the voltage-controlled transistor and outputting a control signal to the voltage-controlled transistor; and wherein
the current control unit compares the amplitudes of the average voltage signal to the reference voltage to adjust the control signal to stabilize the current flow in the current loop.

2. The LED driving circuit as claimed in claim 1, wherein
the current detection unit comprises a resistor, and the voltage of the resistor represents the square DC voltage signal;
the square DC voltage signal is transferred to the average voltage signal by the low-pass filter; and
the average voltage signal and the reference voltage are provided to the current control unit to compare with to adjust the magnitude of the bias voltage to the voltage-controlled transistor.

3. The LED driving circuit as claimed in claim 1, wherein the low-pass filter is a digital filter.

4. The LED driving circuit as claimed in claim 2, wherein the low-pass filter is a digital filter.

5. The LED driving circuit as claimed in claim 3, wherein the low-pass filter is a down-sampled sinc filter

6. The LED driving circuit as claimed in claim 4, wherein the low-pass filter is a down-sampled sinc filter.

7. The LED driving circuit as claimed in claim 1, wherein the low-pass filter is an analog filter.

8. The LED driving circuit as claimed in claim 2, wherein the low-pass filter is an analog filter.

9. The LED driving circuit as claimed in claim 5, wherein the voltage-controlled transistor is a MOSFET having
a drain and a source connected in the current loop; and
a gate set as the control terminal.

10. The LED driving circuit as claimed in claim 6, wherein the voltage-controlled transistor is a MOSFET having
a drain and a source connected in the current loop; and
a gate set as the control terminal.

11. The LED driving circuit as claimed in claim 1, wherein the voltage-controlled transistor is a MOSFET having
a drain and a source connected in the current loop; and
a gate set as the control terminal.

12. The LED driving circuit as claimed in claim 2, wherein the voltage-controlled transistor is a MOSFET having
a drain and a source connected in the current loop; and
a gate set as the control terminal.
